(19) United States
(12) Patent Application Publication
(10) Pub. No.: US 2011/0135885 A1
(43) Pub. Date: Jun. 9, 2011

(54) Monolithic Composite Panel with Multicell Box Shape

(76) Inventors: Jose Luis Cifuentes Martin, Madrid (ES); Mireya Manzanero Martos, Madrid (ES)

(21) Appl. No.: 11/794,000

(22) PCT Filed: Dec. 29, 2005
(86) PCT No.: PCT/EP05/57214

§ 371 Date: Dec. 14, 2007

(30) Foreign Application Priority Data
Dec. 30, 2004 (ES) 200403149

(51) Int. Cl. B32B 3/12

(52) U.S. Cl. 428/178

(57) ABSTRACT

This invention relates to monolithic composite panel, the structure of which comprises a skin (1), a plurality of omega-shaped stiffeners (3), an also omega-shaped element (5) covering said stiffeners (3).

### FIELD OF THE INVENTION

The invention relates to a monolithic composite panel with a multicell box shape for aircrafts.

### BACKGROUND OF THE INVENTION

Sandwich structures, boxes formed by several finished parts and structures with omega-shaped stiffeners have been used in the known art to obtain structures made of carbon fiber or other composite with high torsion strength.

If the stiffness demands are very high, the discussed structures have several drawbacks: the sandwich-type structure requires thicknesses that are impossible to compact, the structure with omega-shaped stiffeners gives way to very heavy and difficult to manufacture structures due to the little torsion capacity they have all together.

Structures with finished boxes provide a good solution to the torsion problem, but they have the drawbacks of the assembly complexity and the large number of parts.

This invention aims to solve these drawbacks.

### SUMMARY OF THE INVENTION

This invention proposes a monolithic panel made of a composite, of those used in the aeronautical field (hereinafter monolithic composite panel) the structure of which comprises a skin, a plurality of omega-shaped stiffeners and an also omega-shaped element covering said stiffeners, forming a multicell box structure.

Other features and advantages of this invention will be understood from the following detailed description of an illustrative embodiment of its object in relation to the attached drawings.

### BRIEF DESCRIPTION OF THE DRAWINGS

FIG. 1 shows a cross-sectional view of a panel according to this invention.

FIG. 2 shows a panel according to this invention used as a door for an aircraft landing gear.

### DETAILED DESCRIPTION OF THE INVENTION

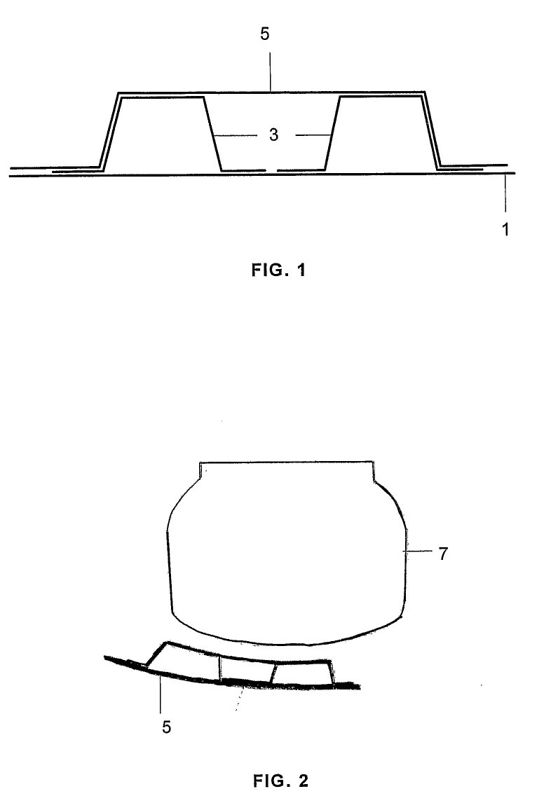

According to FIG. 1, it is observed that the monolithic composite panel according to the invention comprises a skin 1, two omega-shaped stiffeners 3 attached to which is an also omega-shaped element 5 covering the stiffeners 3 like a “blanket”.

In the embodiment of the invention shown in FIG. 1, the element 5 covering two stiffeners 3 but in other embodiments may cover a larger number of stiffeners if a larger number of cells in the box is required.

Generally speaking, the panel has a multicell box shape of 2n-1 cells, n being the number of stiffeners 3.

The panel is formed like a monolithic structure, of a single part without finishes.

The panels according to this invention are particularly useful in those areas requiring a very reduced height, as occurs in the case of doors for large aircraft landing gear requiring a structure with a high torsion capacity under strong weight and space demands, without losing the advantages of the monolithic structures to sandwich structures (many advantages in maintainability and elimination of water intake problems).

Generally speaking, the panels according to this invention are useful when a monolithic structure is required in which the intention is to achieve a high torsion strength without decreasing flexure strength, as well as in structures subjected to great weight and space restrictions.

In this sense, FIG. 2 clearly shows the suitability of the panel of this invention to be used as a door 5 of an aircraft landing gear, given the scarce distance between the door 5 and the landing gear wheel 7.

Any modifications comprised within the scope defined by the following claims can be introduced in the preferred embodiment described above.

1. A monolithic composite panel for aircraft, the structure of which comprises a skin (1) and a plurality of omega-shaped stiffeners (5), characterized in that it also comprises an omega-shaped element (5) covering said stiffeners (3), forming a multicell box shaped structure.

2. A monolithic composite panel for aircraft according to claim 1, characterized in that the element (5) covers two stiffeners (3).
